(19) United States
(12) Patent Application Publication
(10) Pub. No.: US 2013/0236236 A1
(43) Pub. Date: Sep. 12, 2013

(54) Integral mechanical lock

(71) Applicant: Glenn Klecker, Silverton, OR (US)

(72) Inventor: Glenn Klecker, Silverton, OR (US)

(21) Appl. No.: 13/869,850

(22) Filed: Apr. 24, 2013

Related U.S. Application Data
(63) Continuation-in-part of application No. 12/927,474, filed on Nov. 15, 2010, now Pat. No. 8,443,521.

(51) Int. Cl. F16C 11/10; F16B 7/10

(52) U.S. Cl. CPC F16C 11/10; F16B 7/10
USPC 403/84; 403/109.2

(57) ABSTRACT

An integral mechanical lock for securing extensible and pivotal two member tools, comprising a first member having at least one notch and a second member having an integral lock that engages the first member notch locking the first member and second member in position. The integral lock includes a locking bar integrally formed with a support arm that is located between a pressure pad end and a locking end portion, the support arm provides an effective pivot point whereby when force is applied to the pressure pad end, the locking end portion is urged up out of the first member notch releasing the engagement between the first member from the second member. The integral lock may be constructed from a single flat sheet of metal, or further formed with bends or inclusion of other fixated pieces. A safety interlock shim feature works cooperatively with the pressure pad end by preventing the locking end portion from being urged from the notch when the safety interlock shim is located under the pressure pad end.

### CROSS REFERENCE TO RELATED APPLICATION

This application is a continuation-in-part of application Ser. No. 12/927,474 filed on Nov. 15, 2010.

### FIELD

The present disclosure relates generally to an integral mechanical lock, and in particular a lock for securely engaging tools in set positions, releasable with pressure for disengagement.

### BACKGROUND

Common tools having mechanical locks include hand saws, lock back knives, multi-tools, ladders and scaffolding. Other type devices that utilize extension locks include tripods for cameras, extension legs, and telescoping handles. All of these commonly used tools utilize various types of locking mechanisms fixated or attached such that a user can position the tool for use and it locks, and manually pressure to unlock.

For locking into position support structure tools such as ladders or scaffolding, the prior art includes mechanism that secure about a pivot hinge as used in foldable devices, or secure a slidable engagement for extending type devices. Many varieties of mechanical locks of this type include locking hubs, slider shaft, locking pins, and flip over latches.

Locking into position folding ladders is well known in the art and is taught, for example in U.S. Pat. No. 3,692,143 to Kummerlin et al; U.S. Pat. No. 3,794,141 to Sturm; U.S. Pat. No. 4,210,224 to Kummerlin et al; U.S. Pat. No. 4,371,055 to Ashton; and U.S. Pat. No. 4,376,470 to Ashton. Similar to lock back knives or foldable devices having a handle and utensil attached by a pivot, folding ladders generally have positioning pivot joints at the distal ends thereof for permitting movement of the ladder between different angular positions, and releasably fixing the ladder at such selected angular positions. Locking apparatus taught in the prior art involve a plurality of discrete components that work as a system for locking in position. Each component increases the expense of manufacture while requiring maintenance when used.

An example of a foldable ladder having multi-position locking mechanism is taught by inventor Leland Boothe in U.S. Pat. No. 4,407,045. Boothe teaches a mechanical lock as constructed within a hub. The hub comprises a tubular metal housing through which one end of a rotatable shaft projects to engage locking pins. The shaft is spring biased toward retraction within the hub, thereby biasing the locking pins toward their locking position in which they project through aligned holes in the hinge plates as contained within the hub. A radially-extending bore is defined through one end of the hub and contains a bias spring which urges a detent ball radially against the shaft. The shaft, in turn, includes plural truncated spherical recesses disposed at angularly spaced positions at a predetermined axial location of the shaft. Each angular position of the recesses corresponds to a different angular lock position, thereby providing a plurality of angular lock positions of the folding ladder. The many components including springs, detent balls, locking pins, detented shafts and a containment hub make the Boothe lock complicated to manufacture, and susceptible to sticking if not kept clean and maintained regularly.

An example of an extendable and retractable ladder benefiting from a mechanical lock is taught by Shikun Jian in U.S. Application 2009/0065304. Jian teaches a lock engaged by controlling handles that are spring loaded and attached to locking rods that engage by inserting the locking rods through locking holes that engage the pillars of the ladder at the desired position. Jian's locking mechanism requires a plurality of components, all susceptible to grime or grit that may decrease free sliding motion, potentially preventing full insertion of the locking rod into the locking holes, causing the ladder pillars to disengage under load.

For the devices that include a utensil like a foldable knife, hand saw or file, with a handle pivotally connected, the lock back mechanism is one of the simplest and most reliable methods for locking a tool and handle in position through secure engagement of the moving parts. In practice, the lock back mechanism includes a locking bar substantially parallel to the handle of the tool with one end aligned over the upper back or rear tang of the tool. The locking bar is usually fixated as a separate part to the handle with a rivet, or through pin. As the tool rotates to the open position, the locking bar rides along the rear tang with spring tension, until the locking bar engages a notch in the rear tang, locking the tool in the open position. To unlock, the opposing end of the locking bar is depressed pivoting about a pin the locking bar out of the notch and away from the rear tang allowing the tool to close.

Methods of locking a tool to a handle requiring a plurality of components are well known in the art. An example of one alternative method is a locking liner as taught by inventor Ed Halligan in U.S. Pat. No. 6,101,724. The handle has an integral locking bar formed from the same metal as the handle and arranged to exert side forces on the side of the blade as it opens causing wear, and in gritty environments excessive wear. Tolerances for a liner lock design must be precise in order for it to work properly, whereas the tolerances for a lock back are not as critical. The lock back design takes more abuse, has less wear surface between the locking bar and the blade, and is easier and less expensive to manufacture making it the preferred design for a simple pocket knife. Further, the unlocking mechanism of #724 requires a side force applied from a direction perpendicular to the handle, and when the blade unlocks, the user's finger or thumb is aligned with the sharpened blade portion thereby exposing the user to a potential cut hazard.

There are many designs of mechanical locks, most being constructed of many components all interrelating to complicated mechanisms that are susceptible to failure, but none achieve a reliable integrally formed lock for two member tools that are connected about a pivot such as foldable knives, saws, files or foldable ladders. Also, the prior art does not teach or suggest an integral lock for slideably engaging an extension tools in the extended use position that disengages with manual pressure.

### SUMMARY

The present invention relates to a mechanical lock that engages tools securely in the of use position. The term tool herein means any multi-section device that slidably connects, or two member devices that pivotally connects.

Extensible tools such as extendable handles, scaffolding legs, and extension ladders benefit from an integral lock to securely engage to sections together securely when in use referred herein as the “extended” position, and when the lock is disengaged, the extensible tool freely slides within itself referred herein as the “compacted” position. Foldable ladders and tools connected by pivot such as knives or saws, the position of use is referred herein as the “open” position, and when the integral locks is released the two member device is foldable into a condensed position referred herein as the “closed” position.

As used herein, the terms “integral” and “unitary construction” refers to a construction that does not include any welds, fasteners, or other means for securing separately formed pieces of material to each other, as the lock is one continuous piece. The integral lock is incorporated into devices either by unitary construction being built within the tool component in, or by attachment using traditional fixation means such as through fasteners, pins, or welds.

The integral lock consists of a biased locking bar having a pressure pad on one end, and a locking end portion on the other end. Unlocking is performed by applying manual pressure to the locking bar at pressure pad end such that the locking end portion is urged away from the tang notch or lock notch of the other tool component. The locking bar has an effective pivot point located within a supporting arm structure that extends from the locking bar. What is meant by an effective pivot point is that the locking bar flexes at the support arm as if it was pivoting, but without a pivot structure. The support arm may be resiliently biased to increase pressure of the locking end portion using heat treating techniques.

The mechanical lock simplifies the manufacturing processes while eliminating the need for additional individual discrete parts. The elegant unitary construction of the mechanical lock is easily manufactured, simple to use, and as durable as the metal from which it is constructed.

Depending on manufacturing method and application, the locking mechanism may require an additional step to provide the desired resilient characteristics. For example, if the material is steel or other heat treatable material, the locking mechanism is heat treated after being deformed to the desired resilient position thereby creating a spring biased form without the need of adding a spring component. The desired resiliency force to unlock by applying force to the pressure pad end is achieved through the cut out of the lock, heat treating, materials used, or a combination thereof.

The resiliency force may also be modified by changing the thickness or depth of the notch, increasing or decreasing the cross section or the type of material of the support arm component, or altering the relative location of the support arm component as integrally formed between the pressure pad end and the locking end portion. To explain, extending the pressure pad end further from the support arm and locking end portion reduces the amount of force needed to release the locking end portion proportional to the increased leverage.

The integral lock benefits from a safety interlock shim feature executed by sliding a shim or spacer underneath the pressure pad end or through the lock bar, thereby preventing accidental release of the lock. The safety interlock shim feature is especially useful on tools such as ladders where redundant locking systems are favored to ensure safety of the user.

Further characteristics and advantages of the present invention will become better apparent from the following detailed description of the preferred but not exclusive embodiments of the mechanical locking device for tools of the type with two pivoted components, such as knives, saws, files, foldable ladders, and the like, and tools of the type with multiple sections slidably engages such as scaffolding legs, extension ladders, extendable handles, and the like, according to the invention, illustrated by way of non-limiting example in the accompanying descriptions and drawings.

### BRIEF DESCRIPTION OF THE DRAWINGS

FIG. 1 is a close up perspective view of the integral lock as unitarily constructed into an extension ladder embodiment.

FIG. 2 is a perspective view of the integral lock unitarily constructed into an extension ladder embodiment.

FIG. 3 is a perspective view of the integral lock unitarily constructed into a foldable ladder embodiment.

FIG. 4 is a side view of the integral lock unitarily constructed into a foldable ladder embodiment.

FIG. 5 is a cutaway side view of the integral lock unitarily constructed into the handle of a foldable saw tool embodiment.

FIG. 6 is a perspective view of the integral lock unitarily constructed into a single side handle section of a lock back knife embodiment.

FIG. 7 is a side view of the handle blank of a one-sided handle embodiment of the folding knife as first depicted as FIG. 7 in application Ser. No. 12/927,474 filed on Nov. 15, 2010.

FIG. 8 is an elevated side view of the one-sided handle embodiment as first depicted as FIG. 8 in application Ser. No. 12/927,474 filed on Nov. 15, 2010.

Reference Table

| | |
|---|---|
| 1. | First Member |
| 2. | Second Member |
| 3A. | Double tooth saw |
| 3B. | Blade |
| 16. | Tang Portion |
| 19. | Pivot Structure |
| 22. | Integral Lock |
| 22A. | One Side |
| 23. | Through Fasteners |
| 23A. | Spacers |
| 30. | Locking bar |
| 36. | Locking End Portion |
| 36A. | Locking Hardware |
| 38. | Pressure Pad End |
| 38A | Pressure Pad Hardware |
| 40. | Support Arm |
| 44. | Arm Depth |
| 46. | Tang Notch |
| 52. | Force |
| 53. | Direction |
| 110. | First Section |
| 120. | Second Section |
| 125. | Notch |
| 130. | Extended Position |
| 136. | Safety Interlock Shim |
| 201. | Open Position |
| 205. | Style Cutout |
| 206. | Ergonomic Grip |

### DETAILED DESCRIPTION

In the embodiments that follow, individual characteristics, given in relation to specific examples, may actually be interchanged with other different characteristics that exist in other embodiments.

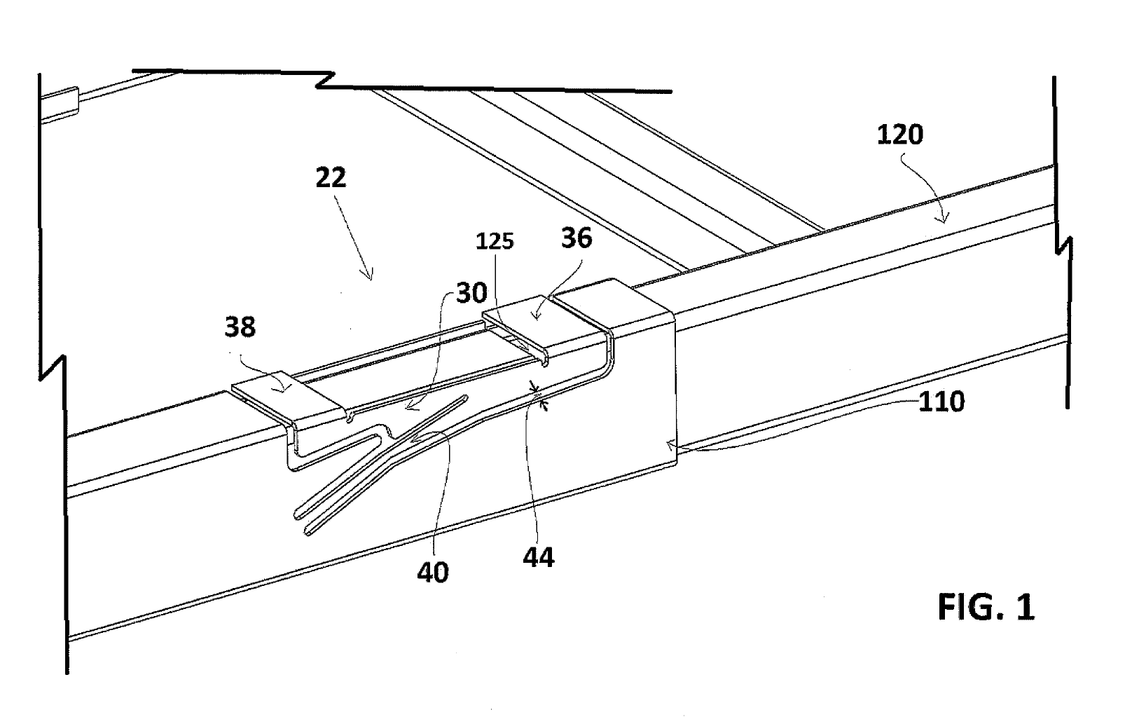

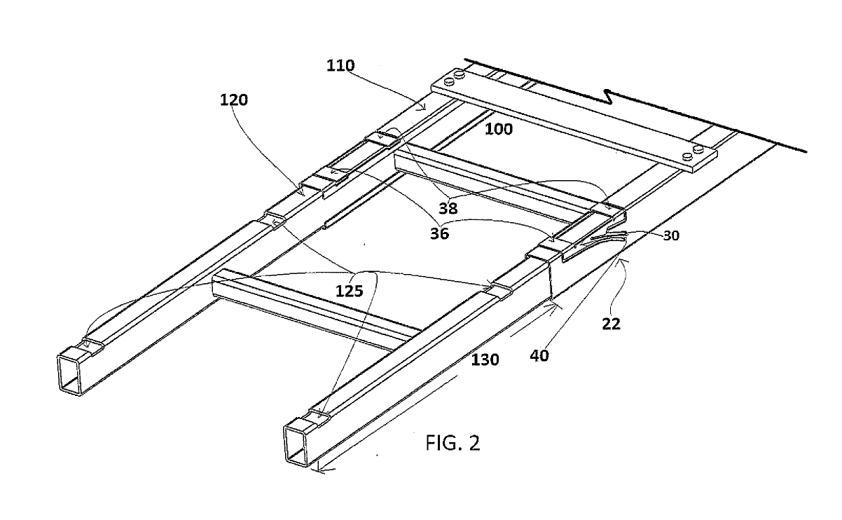

As depicted in FIG. 1 and FIG. 2, the extendable and retractable embodiment shown in a close up perspective in FIG. 1 and in the extended position 130 in FIG. 2 is depicted as an extension type ladder for illustrative purposes, as the integral lock 22 could be used for an extending leg for scaffolding, or a tubular handle extension for a pruning saw or the like. The integral lock 22 secures the position of the first section 110 relative to the second section 120 without the need for any additional fasteners, welds, or discrete components. However, additional hardware could be added for specific applications or for ascetic enhancement. The outer sections 110 and inner sections 120 slidably engage which can be along a track, a groove, or as shown, a tube within a tube configuration. The embodiment depicted in FIGS. 1 and 2 illustrate the tube within a tube configuration and the outer sections 110 and inner sections 120 may be constructed from square, round, or rectangular tubing allowing for the first section 110 is formable to include an integral lock 22, and the second section 120 includes at least one notch 125. Or alternatively the first section 110 includes at least one notch 125, and the second section 120 is formable to include an integral lock 22.

The integral lock 22 as used in extendable tools depicted in FIGS. 1-2, may be constructed of any suitable material. For the extendable ladder embodiment, the first section 110 and second section 120 are constructed from rectangular tubing, with the second section 120 having an outside dimension less than the inner dimension for the first section 110 as shown in FIG. 1. The thicker the square tubing wall the thicker the support arm 40, which equates to a greater resiliency or spring like characteristic of the locking bar 30. As an alternative to thicker and heavier tubing, resiliency or positive spring like pressure may be increased as shown in FIG. 1 by increasing the arm depth 44 of the support arm 40 which allows further biasing of the locking end portion 36. The support arm 40 may be further enhanced through heat treatment techniques in order to achieve the desired resiliency. The resiliency of the integral lock 22 defines the force required at the pressure pad end 38 to unlock the first section 110 in relation to the second section 120.

The bias of the support arm 40 is desirably strong enough to retain the locking end portion 36 in resistive sliding contact with the second section 120 between notches 125, and upon the locking end portion 36 aligning with a notch 125 as depicted in FIG. 1. Upon the locking end portion 36 engages within the notch 125, the second section 120 is securely located in relation to the first section 110. Upon the locking end portion 36 dropping into the notch 125, the pressure pad end 38 raises slightly in opposition like a teeter totter, and upon the pressure pad end 38 being pushed down, the locking end portion 36 lifts from the notch 125 releasing the second section 120 from the first section 110. The bias of the support arm 40 is preferably limited such that manual pressure by a user's thumb or finger is adequate to lift the locking end portion 36 thereby disengaging the second section 120 from the first section 110.

As shown in FIG. 2, second section 120 slidably engages within the first section 110, the second section 120 having notches 125 commensurate with extended location positions 130. The integral lock 22 formed from the first section 110, such that the locking end portion 36 engages the notch 125 upon the second section 120 and first section 110 reaching an extended position 130 that aligns the notch 125 with the locking end portion 36. As discussed above, when extended to the location having the notch 125 aligns with the locking end portion 36 the integral lock 22 securely engages the first section 110 in relative position with the inner portion 120 until released. To release the integral lock 22, pressure is applied to the pressure pad end 38 which flexes the support arm 40 lifting the locking end portion 36 out of the notch 125, allowing the second section 120 and first section 110 to freely slide relative to one another.

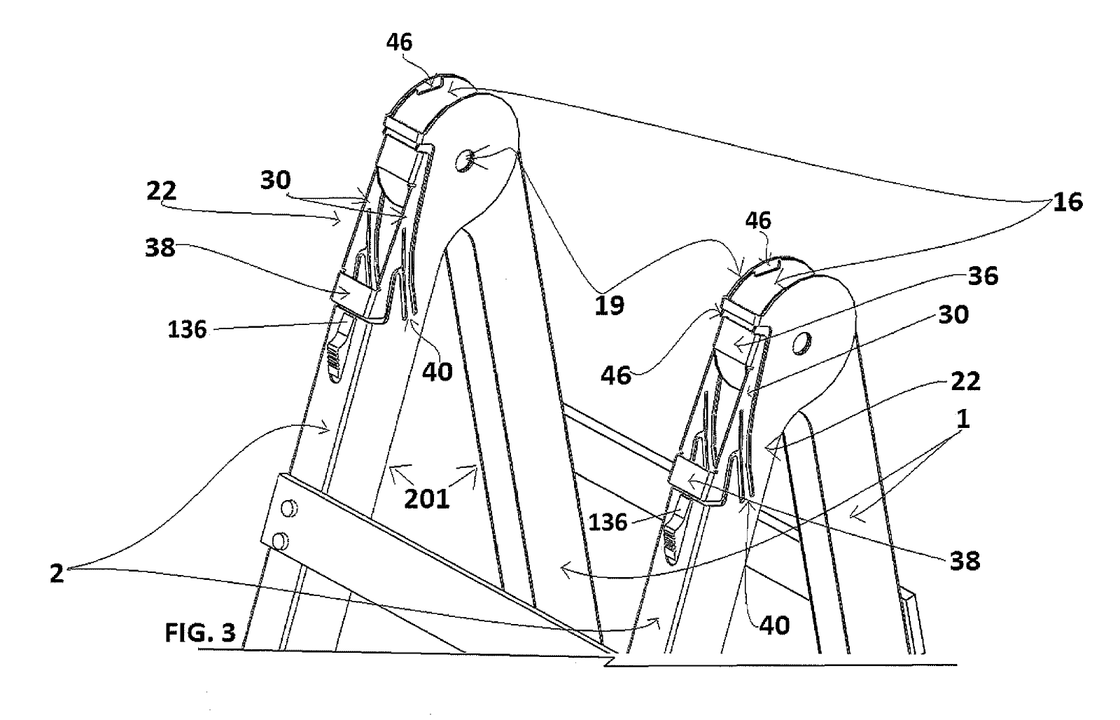

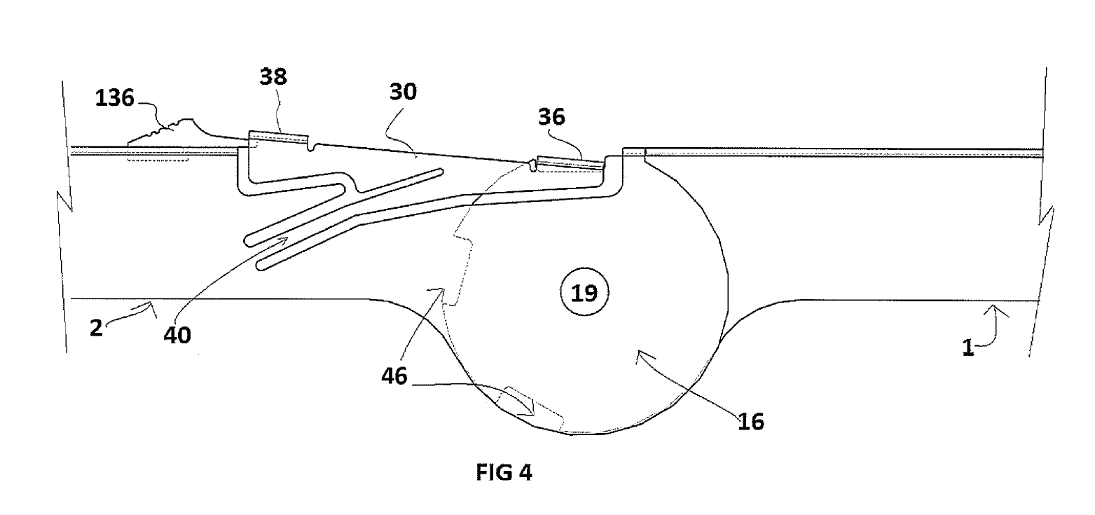

Similar to extendable tools, foldable pivot tools benefit from the integral lock 22 as illustrated by example in FIGS. 3-6. The foldable ladder embodiment as shown in FIGS. 3 and 4 includes a first member 1 and a second member 2 connected by a pivot structure 19, the pivot structure 19 being constructed as simply as a through pin as shown, or as complicated as an inset bearing. The first member 1 includes a tang portion 16, the tang portion 16 having at least one tang notch 46 formed to match the shape and size of the locking end portion 36 of the integral lock 22 which is shown as cut out from the second member 2. As with the extensible tool embodiment shown in FIGS. 1 and 2, the integral lock 22 has a locking bar 30 integral with a support arm 40 continuously formed between a locking end portion 36 and a pressure pad end 38 constructed and arranged to lock the first member 1 in relation to the second member 2 when the locking end portion 36 engages the tang notch 46 defining the open position 201, and unlocks the first member 1 in relation to the second member 2 when force is applied to the pressure pad end 38 urging the locking end portion 36 from the tang notch 46 disengaging the first member 1 to pivot freely in relation to the second member 2. For further positive securing, a safety interlock shim 136 locates under the pressure pad end 38 such that the locking end portion 36 cannot be urged from the tang notch 46 while the safety interlock shim 136 is in place. The safety interlock shim 136 may be used in any of the embodiments demonstrated in FIGS. 1-6.

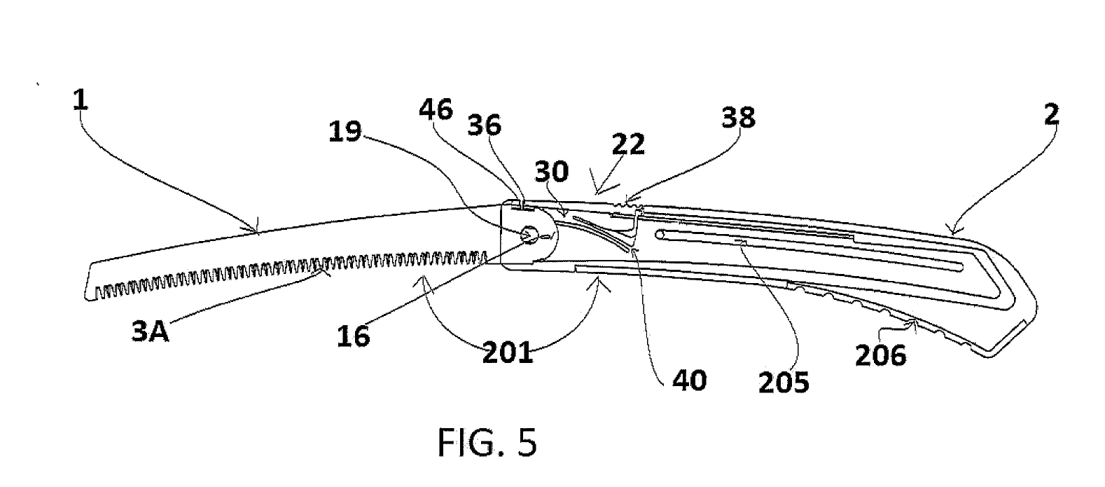

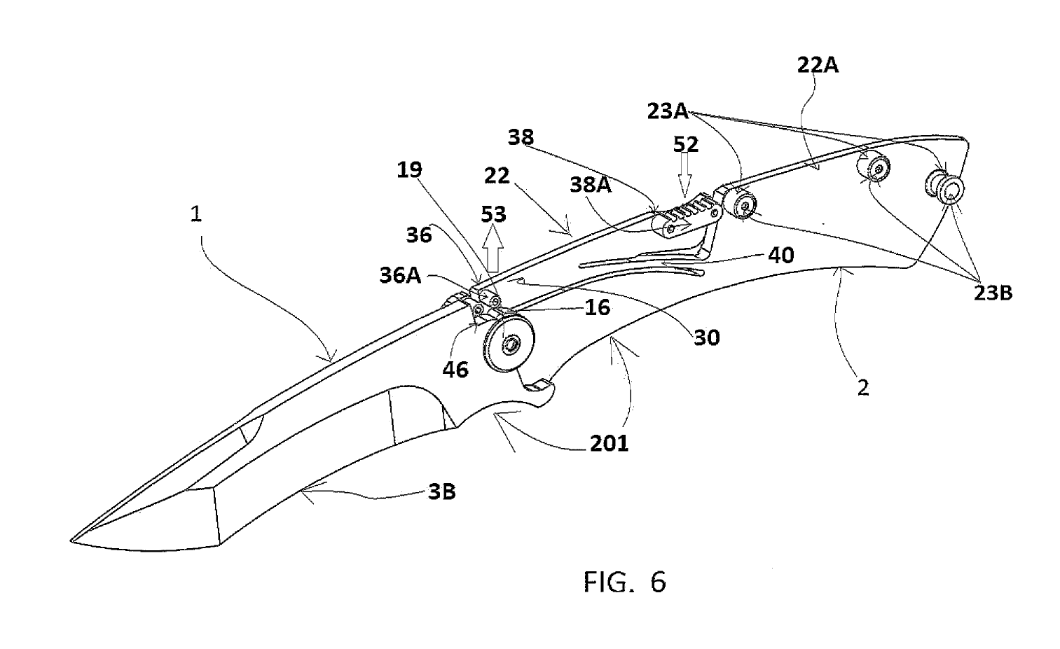

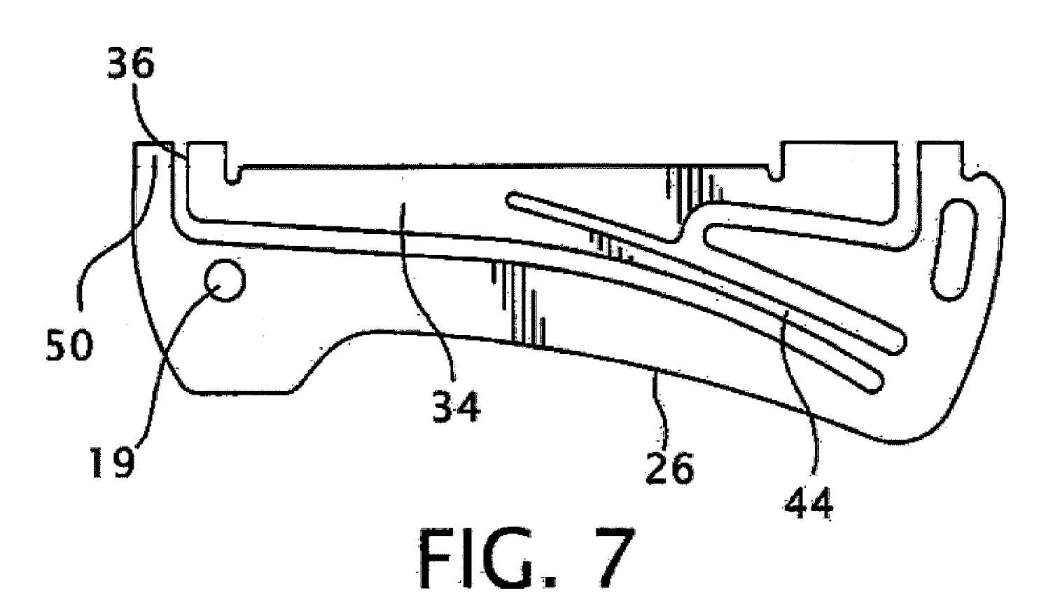

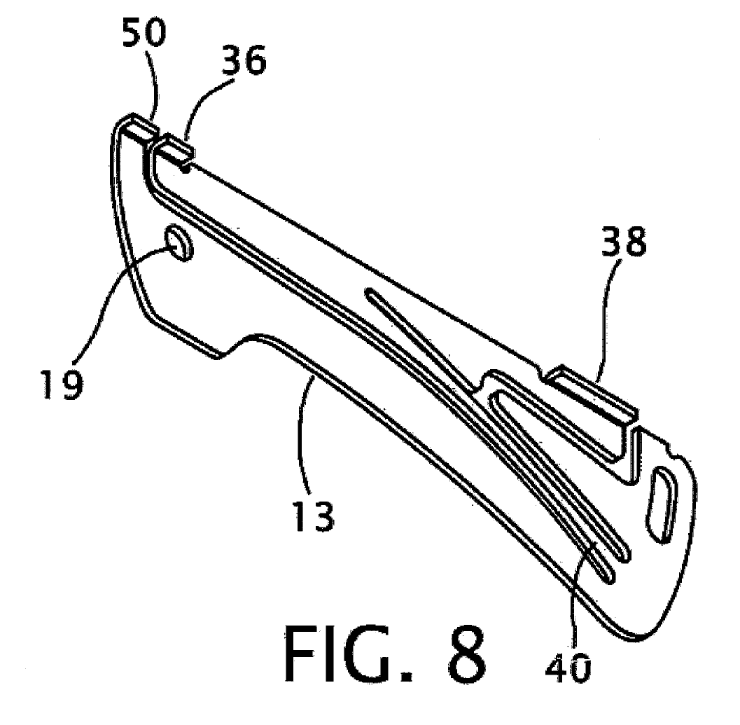

As shown in FIGS. 5 and 6 are two exemplary embodiments of foldable pivot hand tools benefiting from the integral lock 22 constructed from a flat sheet of metal. As shown in FIGS. 7 and 8, the integral lock 22 may be further formed through bending to create an integrally formed spine 50 to increase rigidity, or to increase surface contact areas of the locking end portion 36 or pressure pad end 38 as depicted in FIG. 8.

The cutaway side view in FIG. 5 demonstrates the integral lock 22 as used in a fold out saw embodiment. In FIG. 6 is a perspective view of a foldable knife embodiment with single flat side 22A formed into the inventive integral lock 22 as cut out from a flat sheet of metal. Both of these embodiments represent a foldable pivot tool configuration using the integral lock 22, each having two members, a first member 1 “utensil” and second member 2, “handle”, the first member 1 and second member 2 being connected about a common pivot structure 19. The first member 1 could be any of a variety of ‘utensils’ to include knives, files, saws, or similar type devices. The second member 2 includes at least one integral lock 22 cut out or punched from a flat sheet of metal, as better depicted in FIG. 6-8. Non-locking handle parts or handle inlays constructed of wood, plastic, metal or bone are readily fixated to the second member 2 for desired for aesthetics, ergonomic fit, floatation, or other application specific purposes.

In FIG. 5 the fold out hand saw embodiment is shown in the open position 201 having the integral lock 22 engaged such that the first member 1 is locked in position relative to the second member 2. As previously mentioned, decorative components are readily attached to the second member 2 and the second member 2 may be specially formed with a style cutout 205 or ergonomic grip 206. The robust design of the integral lock 22 readily allows embellishments to the second member 2 such as the style cutout 205 and the ergonomic grip 206 without altering the functional characteristics or effectiveness of the integral lock 22. The fold out saw embodiment includes a first member 1 having a tang portion 16, the tang portion 16 having at least one tang notch 46 and a pivot structure 19. Here the first member 1 includes a double tooth saw 3A that folds up into the second member 2. The second member 2 is connected by the pivot structure 19 to the first member 1 and includes an integral lock 22 that is formed from the continuous metal of the second member 2. The pivot structure 19 pivotally mounts the first member 1 to the second member 2 such that when the first member 1 and second member 2 pivot to position allowing the locking end portion 36 to engage the tang notch 46 for the in use or open position 201 as depicted. To release, pressure is applied to the pressure pad end 38 urging the locking end portion 36 out of the tang notch 46, freeing the first member 1 to rotate in relation to the second member 2.

The integral lock 22 depicted in FIG. 6 functionally locks and unlocks the in the same manner as the foldable hand saw embodiment shown in FIG. 5, and for consistency the same numerics are used to identify the components of the integral lock 22. FIG. 6 shows the integral lock 22 from a perspective view to illustrate in three dimensions that the integral lock 22 is cut from one flat side 22A of sheet metal by simply punching out the pattern of the blank requiring no further forming or bending. Folding or bending over a spine 50 (Shown in FIGS. 7 and 8) increases strength and rigidity, however is not necessary in many smaller hand tool application. The locking bar 30, support arm 40, locking end portion 36 and pressure pad end 38 are all unitarily formed from a continuous sheet of metal of the one flat side 22A. The locking end portion 36 further includes a fixated locking hardware 36A that as attached to the locking end portion 36 enhances locking capability.

As shown in FIG. 6, the at least one side 22A is complimented with fixated hardware including spacers 23A and through fasteners 23B that would allow locating for example a non-locking handle side (not shown) and fixating the same to the at least one side 22A allowing unlimited options in handle configurations as constructed around or adjacent to the second member. Depending on the resiliency of the support arm 40, significant force 52 may be required at the pressure pad end 38 to lift the locking end portion 36 from the tang notch 46. To increase the surface are of contact making it easier to apply manual force 52, pressure pad hardware 38A is included as fixated adjacent to, on top of, or next to the pressure pad end 38 such that the force 52 to disengage the integral lock 22 is more comfortably applied. The pressure pad end 38 and pressure pad hardware 38A as shown readily benefits from non-slip texture and finger shape to increase positive feel and secure contact by the user when applying manual force 52 for unlocking.

The unlocking of the first member 1 in relation to the second member 2 is performed by applying force 52 at the pressure pad end 38 or at the pressure pad hardware 38A. For the one-sided embodiment depicted in FIG. 6, the narrow surface area of the pressure pad end 38 that could make releasing the integral lock 22 difficult for some users is overcome by the inclusion of the pressure pad hardware 38A. The pressure pad hardware 38A as shown is fixated to the side or top of the pressure pad end 38 by through fastener, but may be fixated using any suitable method.

The support arm 40 as discussed above provides the effective pivot point for the locking bar 30 and defines the resilient bias of the integral lock 22. As shown in FIG. 6, the robust design of the integral lock 22 allows for the inclusion of hardware such as pressure pad hardware 38A, locking hardware 36A, spacers 23A or through fasteners 23B as attaching to the second member 2 without materially altering function or changing the performance of the integral lock 22.

As first depicted in FIGS. 7 and 8 in application Ser. No. 12/927,474 filed on Nov. 15, 2010 now shown for comparative reference in FIG. 7 having the second member 2 in blank form prior to bending, and FIG. 8 showing the second member 2 benefiting from a forming 90 degree bend. Both embodiments depicted in FIGS. 7 and 8 were cut out of a flat sheet of metal and then as FIG. 8 depicts further formed by bending to form the spine 50 for example. As shown in FIG. 6, the integral lock 22 is fully formed without any further forming or bending. To form the second member 2 in FIG. 6, a blank is cut out of a flat sheet of metal leaving the integral lock 22 unitarily constructed within the second member 2. Unlike embodiments shown in FIG. 8, there is no further forming with bends after the blank is punched out, thus leaving the integral lock 22 flat as the sheet of metal that the second member 2 was cut from.

The inclusion of the spine 50 shown in FIG. 8 increases rigidity and strength at the locking end portion 38 which is similarly achieved by the inclusion of the locking end hardware 36A as shown in FIG. 6. The pressure pad end 38 as shown in FIG. 8 benefits from a 90 degree bend thereby increasing the contact area similar to the inclusion of the pressure pad hardware 38A depicted in FIG. 6. The inclusion of the spine 50, locking hardware 36A, and pressure pad hardware 36A are examples of enhancements to the integral lock 22, but are not necessary to its function.

For the embodiments shown in FIGS. 1-8, the support arm 40 is cut out of the same continuous sheet of metal as the locking bar 30, pressure pad end 38, and the locking end portion 36. Desired resiliency, locking strength and release pressure are achieved by increasing or decreasing the thickness of the continuous sheet of metal, shape and thickness of the support arm 40, heat treatment, or combinations of the same. To increase the locking hold of the integral lock 22 for the extensible tool embodiment, the notches 125 are cut deeper to more positively set the locking end portion 36. For further positive securing, a safety interlock shim 136 as shown in FIGS. 3 and 4 locates under the pressure pad end 38 such that the locking end portion 36 cannot be urged from the notch 125 while the safety interlock shim 136 is in place.

The foregoing description of the preferred embodiments to include extensible devices and pivot tools each incorporate the present invention have been presented for the purpose of providing an illustrative disclosure and enabling description. It is not intended to be exhaustive or to limit the invention to the precise form disclosed, as the integral lock can be utilized on both pivot and extensible tools. Many modifications and variations are possible in light of the above teachings. All the details may be replaced with other technically equivalent ones. In practice, the materials used, as well as the shapes and the relative dimensions, may be any according to requirements without thereby abandoning the scope of the protection of the appended claims. Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs. It is intended that the scope of the present invention not be limited by this detailed description, but by the claims and the equivalents to the claims appended hereto.

I claim:

1. An integral lock for an extendable tool, comprising:
at least two sections, a first section 110 and a second section 120, the second section 120 being constructed and arranged to slidably engage in cooperation with the first section 110, the first section 110 having an integral lock 22 formed on at least one side, the second section 120 having at least one notch 125 formed on at least one side;
the integral lock 22 having a locking bar 30 integral with a support arm 40 continuously formed between a locking end portion 36 and a pressure pad end 38 constructed and arranged to lock the first section 110 in relation to the second section 120 when the locking end portion 36 engages into the notch 125 defining the extended position and unlocks the first section 110 in relation to the second section 120 when force is applied at the pressure pad end 38 urging the locking end portion 36 out of the notch 125 unlocking the second section 120 from the first section 110.

2. An integral lock for a foldable pivot tool, comprising:
a first member 1 having a tang portion 16, the tang portion 16 having at least one tang notch 46;
a second member 2 having an integral lock 22 formed therefrom;
a pivot structure 19 pivotally mounting the first member 1 to the second member 2;
the integral lock 22 having a locking bar 30 integral with a support arm 40 continuously formed between a locking end portion 36 and a pressure pad end 38 constructed and arranged to lock the first member 1 in relation to the second member 2 when the locking end portion 36 engages the tang notch 46 defining the open position 201, and unlocks the first member 1 in relation to the second member 2 when force is applied to the pressure pad end 38 urging the locking end portion 36 from the tang notch 46 unlocking the first member 1 to pivot freely in relation to the second member 2.

3. The integral lock of claim 1, in which the first section 110 and second section 120 are ladder members constructed from square or rectangular tubing.

4. The integral lock of claim 1, further comprising a safety interlock shim 136 constructed and arranged to insert under the pressure pad end 38 such that the locking end portion 36 cannot be urged out of the notch 125.

5. The integral lock of claim 2, wherein the integral lock 22 is fully formed flat as the sheet of metal from which second member 2 was cut from.

6. The integral lock of claim 2, wherein the pressure pad end 38 further includes a fixated pressure pad hardware 38A.

7. The integral lock of claim 2, wherein the locking end portion 36 further includes a fixated locking hardware 36A.

8. The integral lock of claim 2, wherein the second member 2 includes spacers 23A or through fasteners 23B.

9. The integral lock of claim 2, wherein the second member 2 is attached to a non-locking handle portion.

10. The integral lock of claim 2, wherein the second member 2 further includes at least one style cutout 205.

11. The integral lock of claim 2, wherein the second member 2 further includes at least one ergonomic grip 206.

12. The integral lock of claim 2, further comprising a safety interlock shim 136 constructed and arranged to insert under the pressure pad end 38 such that the locking end portion 36 cannot be urged out of the tang notch 46.
